(19) United States
(12) Patent Application Publication
(10) Pub. No.: US 2010/0242851 A1
(43) Pub. Date: Sep. 30, 2010

(54) Systems and Methods for Aquatic Electrified Barriers

(76) Inventors: Lee Carstensen, Vancouver, WA (US); Steven Francis Almquist, Hillsboro, OR (US); Bryan West Hamilton, Vancouver, WA (US)

Correspondence Address: Smith-Root, Inc., 14014 NE Salmon Creek Ave, Vancouver, WA, 98686, US

(21) Appl. No.: 12/727,936

(22) Filed: Mar. 19, 2010

Related U.S. Application Data
(60) Provisional application No. 61/163,576, filed on Mar. 26, 2009.

(51) Int. Cl. A01K 63/00; A01K 61/00

(52) U.S. Cl. 119/220; 119/223

(57) ABSTRACT

A flexible aquatic species barrier having a multiplicity of pulsators, each pulsator further comprising an anode lead, a cathode lead, and an potential difference generator, where each pulsator is proximately attached to a section of net, each section net comprising a anode conductive braid, a cathode conductive braid, and a net interposed between the anode conductive braid and the cathode conductive braid, and where the anode lead of the pulsator is connected to the anode conductive braid, and where the cathode lead of the pulsator is connected to the cathode conductive braid; whereby when one or more of the pulsators are activated, a potential difference is created between the anode conductive braid and the cathode conductive braid; such that when current flows between the anode conductive braid and the cathode conductive braid an aquatic species is repelled from the net.

### RELATED APPLICATIONS

This application claims the benefit of U.S. Provisional Application No. 61/163,576, filed on Mar. 26, 2009, the contents herein incorporated into this application by reference.

### BACKGROUND

The present inventive subject matter relates to the systems and methods to prevent mammals from entering nets in general and from having seals enter gillnets in particular.

Gillnets are a commonly used system used to catch fish. A gillnet generally has three parts: (1) a flotation part, (2) a net part, and a (3) lead or bottom part. (e.g. see the products manufactured by the Sterling Net and Twine Company). A gillnet entraps fish by providing a flexible opening that allows the fish to enter, but, if the fish attempts to retreat from the net the gills of the fish becomes entangled, thus ensnaring the fish in the net.

A problem with fish that are captured by a gillnet is that the fish are then easy prey for other predatory animals. For example, a salmon caught in a sampling gillnet is then easily eaten by a seal because the salmon is immobolized by the net. Furthermore, as gillnets are generally used in the same area as the predators, and as a consequence, the predators associate gill nets with a food source. Consequently, a gill net becomes a conditioned target for predators. For commercial use of gillnets, this results in lower production amounts of fish that are caught. For the scientific use of gillnets, such as in fish population sampling, this can lead to inaccurate results.

Of particular concern is the foraging by pinnipeds on salmon in the vicinity of gillnets. This phenomenon, foraging by pinnipeds, has been observed along the west coast of North America and has increased as pinnipeds (e.g. seals and sea lions) have been designated as protected species since the 1970's. For example, it has been observed that the number of harbor seals in the region of the Fraser River (British Columbia, Canada) has increased to 20 or more. As a result, this has led to the harbor seals foraging on fish in a series of experimental gillnets that are set up in the Fraser River. This foraging has affected the quality of results from the gillnets and makes the determination of fish stock and species composition unreliable.

A small electric potential across the fish results in the alignment of the fish with the electric potential, or electrotaxis. In many cases, the fish will “swim” towards the positive pole (termed “anodic response”). Still larger electric potentials impressed across the fish will result in unconciousness or complete euthanasia of the fish.

Electrofishing barriers has traditionally been used in freshwater lakes and streams and are the subject of U.S. Pat. Nos. 5,445,111; 5,327,854; 4,750,451; 4,672,967; 4,713,315; 5,111,379; 5,233,782; 5,270,912; 5,305,711; 5,311,694; 5,327,668; 5,341,764; 5,551,377; and 6,978,734 which are incorporated herein by reference. Also, electrofishing has been the used to stimulate yields of fishing in conjunction with the use of trawl nets as described in U.S. Pat. Nos. 3,110,978 and 4,417,301 which are also incorporated herein by reference. Systems for controlling electricity in aquatic environments have been described in U.S. Pat. No. 5,460,123 which is incorporated herein by reference.

For pinnipeds, certain voltage levels have been determined to have a deterrent effect on a pinniped. These levels are approximately 0.32 V/cm gradient, a pulse width of 1 millisecond, and a frequency of 2 hz (a duty cycle of 0.5%). At this voltage gradient and duty cycle, the local fish are apparently unharmed. Thus the lower voltage gradients are effective at deterring pinnipeds and yet not affecting fish.

Therefore, what is desired is an apparatus that is attachable to a gillnet to deter predation on fish that are ensnared in the gillnet. What is also desirable is a unit that can be easily attached to the gill net. It is also desired that this apparatus operate at a relatively low electrical level such that it will deter pinnipeds and yet not affect fish.

### SUMMARY

The present inventive subject matter overcomes problems in the prior art by providing a gillnet pinniped system that is designed to inhibit marine mammals from preying on fish caught in gillnets before the fish can be brought aboard the fishing vessel. The system works by generating an electric field between two or more electrodes located on the gillnet. These electrodes are supplied power by a series of floating electronics buoys which are controlled by a person located on the fishing vessel. The electronics buoys are attached to the gillnet via an electrical plug at the time of net deployment.

The buoys are set in the water at a specified increment as the net is unrolled from its spool. Once deployed, the buoys use batteries, capacitors and a control board to generate a series of electric pulses strong enough to deter marine mammals but weak enough to not affect the fish in the area.

When the netting session is finished, the net is rolled back up and the buoys are disconnected and stacked. While not in use, the buoys are attached to a battery charging network to maintain the internal batteries

These and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 is a view of the prior art of gill nets and their placement in a water body.

FIG. 2 is a representative embodiment of the diagram of the gill net, the gill net electrifier, and representative predators and the prey fish.

FIG. 3 is a mechanical diagram of the preferred embodiment of the gill net electrification system.

FIG. 4 is the electrical circuit diagram of the preferred embodiment of the gill net electrification system.

### LIST OF REFERENCE CHARACTERS

100—Gillnet
110—Net
120—Float
130—Anchor
200—Electrified Gillnet
210—Net
220—Float
230—Anchor
235—Lead Line
260—Pulsator
270—Anode Braid
280—Cathode Braid
300—Housing
310—Lid
320—Interior
330—Electrical Boards
340—Housing

### DETAILED DESCRIPTION

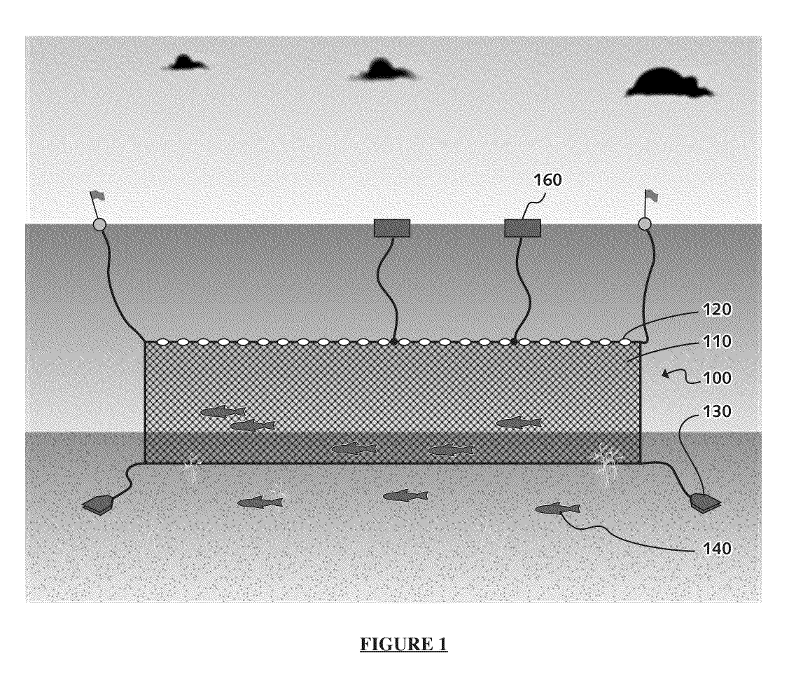

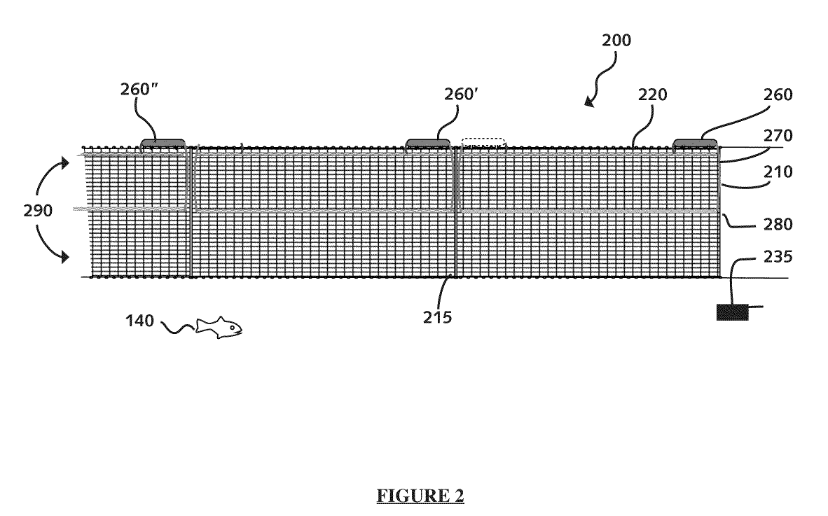

Representative embodiments according to the inventive subject matter are shown in FIGS. 1-8, wherein similar features share common reference numerals.

The term “fish” refers to aquatic fish generally caught by gillnets, but, can include those fish whose capture is incidental to gillnetting, which includes, but is not limited to salmon. “Target fish” generally refers to a size and species that is desired to be caught by gillnet.

The term “gillnet” is generally known to those in the arts as a large rectangular net that is submersible with net holes that are approximately that is slightly smaller than the exterior size of the target fish.

The term “electrical stimulation” refers to an electrical field impressed on the tissue of a fish in water. This electrical field will have a range in values that is dependent on the size and orientation of the fish.

The term “pulsator” shall mean a device that can output a range of voltages and currents in a waveform that is programmed either by hardwire switch (e.g., a pulse generator) or by software (e.g. a computer controlled voltage generator).

Now referring to FIG. 1 which depicts the prior art bottom set gillnet 100 with a net 110, a float 120, and an anchor 130. Fish 140 are proximate to the bottom set gillnet 100 with the possibility of being ensnared.

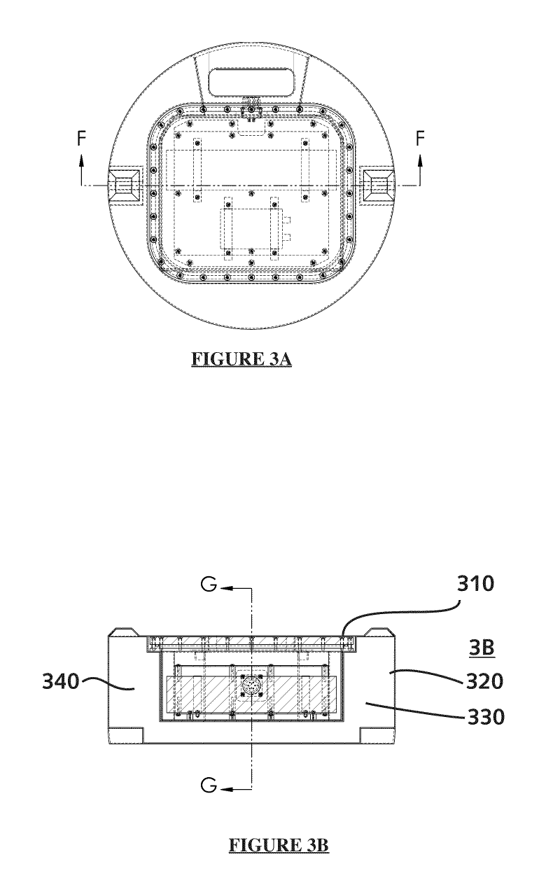

Now referring to FIG. 2 which depicts a view of the electrified gillnet 200. The electrified gillnet 200 has a net 210, float 220, an anchor 230, an pulsator 260, an anode braid 270, and a cathode braid 280. The anode braid 270 and the cathode braid 280 are electrically connected to the pulsator 260. In one embodiment, the anode braid 270 and the cathode braid 280 are separated by a distance of 2 fathoms (12 feet). In the preferred embodiment, a bottom net 215 runs from the cathode braid 280 to an uncharged lead line 235. The cathode braid 280 and the anode braid will be constructed with wire sufficient to carry current without much resistance.

When the pulsator 260 is activated, a potential field 290 is set up between the anode braid 270 and the cathode braid 280. Current flows (not shown) in the water along the potential field lines between the anode braid and the cathode braid. Fish 140 and other aquatic animals (e.g. mammals and/or pinnipeds). The current that flows in the water is also conducted through the body of the fish 140 or the aquatic animal. The potential difference across the fish 140 or an aquatic animal causes a physiological response that can range from discomfort to death.

In one embodiment of the electrified gillnet 200, the length of the anode braid 270 and the cathode braid 280 is approximately 50 feet in distance. The anode braid 270 and the cathode braid 280 are constructed with copper wire with a diameter of 8 gauge, although types of wire may be used.

Once again referring to FIG. 2 which also depicts the mechanical structure of one embodiment of the electrified gillnet 200. The electrified gillnet 200 may be linearly expanded in sections by adding one segmented sections, each with an independent pulsator 260′ that is connected to an independent anode braid 270′ and cathode braid 280′.

In the preferred embodiment, the pulsator 260 generates a pulsed DC output. The pulsed DC output can vary from ½ to 10 pulses per second, with a preferred operating pulse of approximately 2 pulses per second. The potential difference between the anode braid and the cathode braid can range from 100V to 300V. The width of the pulse can be varied from 0.5 milliseconds to 5.0 milliseconds. For a length of gillnet that is 50 ft, a water conductivity of 175 microsiemens, a voltage differential of 300V, the current draw will be approximately 45 Amps. When this configuration is operating at a frequency of 2 pulses per second and a duty cycle of 1% (5 millisecond pulse width within a 500 millisecond pulse). The system will generate approximately 15 Watts of power at the aforementioned current and duty cycle.

The method of operating the electrified gillnet according to FIG. 2 is as follows. A boat strings the gillnet from a starting point to an ending point across an area that is to be protected. The gillnet is broken into a series of independently conductive sections with lengths of approximately 50 feet. The pulsator 260 is attached to each conductive section of the gillnet in a sequential fashion. Each pulsator 260 is activated either by a switch mechanism located on the pulsator 260 or by a remote control device. While each pulsator 260 is active, an electrical field is generated between the anode braid 270 and the cathode braid 280.

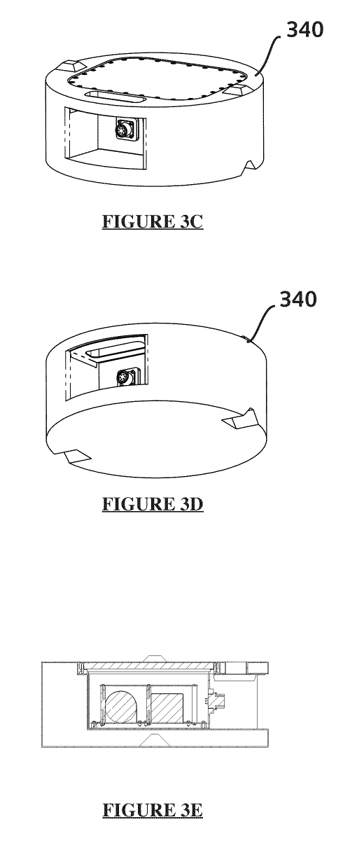

Now referring to the FIG. 3A-E which are mechanical drawings depicting different orientations of the housing 300. The top view (FIG. 3A) of the housing shows the preferred embodiment as a circular container with a diameter of approximately 18⅝″. The side view (FIG. 3B) depicts the lid 310, the interior 320, and the location of the electrical boards 330. When the lid is placed on the housing 340 a water tight seal is formed. Perspective views of the housing 340 are shown in FIGS. 3C and 3D. FIG. 3E depicts a cutaway interior view of the device showing the interior circuit board and battery.

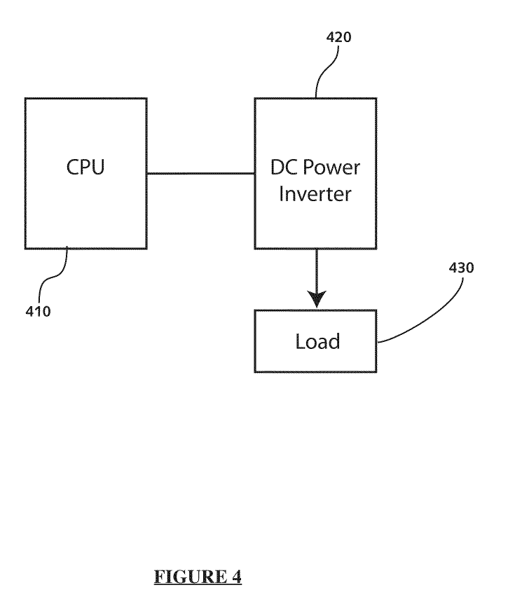

Now referring to FIG. 4A which shows a circuit diagram of one of the circuit boards of the pulsator 260. The pulsator 260 is controlled by a CPU 410 which controls the conversion of low voltage DC power (approx 12-24 VDC) to high voltage pulsed DC output (approx 100-300 VDC) 420 which is connected to the output load (gill net) 430.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

1. A flexible aquatic species barrier comprising:
a multiplicity of pulsators,
each pulsator further comprising an anode lead, a cathode lead, and an potential difference generator,
where each pulsator is proximately attached to a section of net, each section net comprising a anode conductive braid, a cathode conductive braid, and a net interposed between the anode conductive braid and the cathode conductive braid, and where the anode lead of the pulsator is connected to the anode conductive braid, and where the cathode lead of the pulsator is connected to the cathode conductive braid;
whereby when one or more of the pulsators are activated, a potential difference is created between the anode conductive braid and the cathode conductive braid;
such that when current flows between the anode conductive braid and the cathode conductive braid an aquatic species is repelled from the net.

2. The flexible aquatic species barrier as described in claim 1 wherein the potential difference ranges from 50 to 400 volts.

3. The flexible aquatic species barrier as described in claim 1 wherein the potential difference ranges from 100 to 300 volts.

4. The flexible aquatic species barrier as described in claim 1 wherein the potential difference ranges from 275 to 325 volts.

5. The flexible aquatic species barrier as described in claim 1 wherein the length of the net ranges from 10 to 100 feet.

6. The flexible aquatic species barrier as described in claim 1 wherein the length of the net ranges from 30 to 70 feet.

7. The flexible aquatic species barrier as described in claim 1 wherein the length of the net ranges from 45 to 55 feet.

8. The flexible aquatic species barrier as described in claim 1 wherein the potential difference further comprises a pulsed DC waveform.

9. The flexible aquatic species barrier as described in claim 8 wherein the pulse DC waveform cycle ranges from 0.01% to 10%

10. The flexible aquatic species barrier as described in claim 9 wherein the pulse DC waveform cycle ranges from 0.1% to 2%

11. The flexible aquatic species barrier as described in claim 9 wherein the pulse DC waveform cycle ranges from 75% to 1.25%

12. A method of deterring aquatic species comprising the steps of:
attaching an anode braid on the top of a net,
attaching a cathode braid on the bottom of a net,
connecting a pulsator to the anode braid and the cathode braid,
such that when the pulsator is activated a potential difference is created between the anode braid and the cathode braid resulting in a electric field that deters aquatic species.

13. The method of deterring aquatic species as in claim 12 further comprising the steps of:
attaching a separate pulsator to each subsection of net, such that multiple pulsators to energize separate portions of the gillnet.

14. The method of deterring aquatic species as in claim 12 further comprising the steps of:
initiating the pulsator by a remote control device.

15. A system for the deterrence of aquatic species comprising:
an anode braid,
a cathode braid, proximately separated from the anode braid by a net,
a means for creating a potential difference between the anode braid and the cathode braid,
such that when the potential difference is created aquatic species are repelled.

16. The system for the deterrence of aquatic species as in claim 15 further comprising:
a means for controlling the potential difference between a minimum voltage of 100 voltage and a maximum of 300 volts.

17. The system for the deterrence of aquatic species as in claim 15 further comprising:
a means for controlling the potential difference wherein the potential difference is a pulsed DC waveform.

18. The system for the deterrence of aquatic species as in claim 17 wherein the pulsed DC waveform further comprises a duty cycle between 0.5 to 1.5%.

19. A system for controlling aquatic species through the electrification of a body of water by the process of:
placing pulsators on the water;
attaching the pulsators to an anode braid and a cathode braid, the anode braid and the cathode braid connected to the top and bottom part of a net respectively,
such that when the pulsator is activated, an electric field is created in the water.

20. The system as in claim 19 wherein the potential difference between the anode braid and the cathode braid have a potential difference in the range from 100 to 300 volts.
